(19) United States
(12) Patent Application Publication
(10) Pub. No.: US 2026/0158919 A1
(43) Pub. Date: Jun. 11, 2026

(54) ELECTRICAL ENERGY MANAGEMENT SYSTEM AND METHOD OF VEHICLE PERFORMING REGENERATIVE BRAKING

(71) Applicants: HYUNDAI MOTOR COMPANY, SEOUL (KR); KIA CORPORATION, SEOUL (KR)

(72) Inventors: Jung Ro Yoon, Hwaseong-si (KR); Sung Hyun Cho, Hwaseong-si (KR); Seong Jae Yoo, Hwaseong-si (KR)

(73) Assignees: HYUNDAI MOTOR COMPANY, SEOUL (KR); KIA CORPORATION, SEOUL (KR)

(21) Appl. No.: 19/251,999

(22) Filed: Jun. 27, 2025

(30) Foreign Application Priority Data
Dec. 9, 2024 (KR) 10-2024-0181578

(51) Int. Cl. B60L 1/00; B60K 35/10; B60K 35/28; B60L 7/10; B60L 50/15; B60L 50/75

(52) U.S. Cl. CPC B60L 1/003; B60K 35/10; B60K 35/28; B60L 7/10; B60L 50/15; B60L 50/75; B60K 2360/167; B60L 2240/54; B60L 2250/26

(57) ABSTRACT

An electrical energy management system of a vehicle configured to perform regenerative braking includes: a battery configured to store regenerative braking energy generated by a motor; a water storage configured to store water; and a water electrolyzer configured to receive the water stored in the water storage and the regenerative braking energy generated by the motor as electrical energy, and produce hydrogen using the received water and regenerative braking energy. The system also includes: a hydrogen storage configured to store the hydrogen produced by the water electrolyzer; an air conditioner configured to receive electrical energy stored in the battery and the regenerative braking energy generated by the motor; and a controller configured to supply the regenerative braking energy to the water electrolyzer and the air conditioner.

### CROSS-REFERENCE TO RELATED APPLICATION

This application claims under 35 U.S.C. § 119(a) the benefit of and priority to Korean Patent Application No. 10-2024-0181578, filed on Dec. 9, 2024, the entire contents of which are incorporated herein by reference.

### BACKGROUND

### (a) Technical Field

The present disclosure relates to an electrical energy management system and method of performing regenerative braking of a vehicle. More particularly, the present disclosure relates to a vehicle that may enable constant intervention of regenerative braking during braking of the vehicle and enable efficient use of surplus regenerative braking energy that is not capable of recharging a battery.

### (b) Background Art

Eco-friendly vehicles are vehicles that are driven by electrical driving power, and use a motor as a driving device to drive the vehicle. Eco-friendly vehicles are equipped with a motor that generates driving power, an inverter that drives and controls the motor, and an energy storage system that stores electrical energy to drive the motor.

The inverter is an important component that controls current applied to the motor. The energy storage system is a main source of electrical energy, which may include a general high-voltage battery installed in an eco-friendly vehicle.

In an eco-friendly vehicle that is driven by electrical driving power, i.e., the driving power of a motor, the battery of the energy storage system is connected to the motor via the inverter so as to be capable of being charged and discharged.

In addition, when braking or coasting of a vehicle that is driven by a motor, regenerative braking in which the kinetic energy of the vehicle is recovered as electrical energy using the motor as a generator may be performed.

During regenerative braking, the motor is operated as a generator by the rotational force of driving wheels to generate electrical energy. The generated electrical energy is used to charge a battery so that the vehicle is decelerated by an amount corresponding to the generated electrical energy.

Eco-friendly vehicles that are driven by a motor and perform regenerative braking by the motor include a battery electric vehicle (BEV) that is equipped with a motor as a driving source to drive the vehicle and a battery as a power source. Furthermore, eco-friendly vehicles may include a fuel cell electric vehicle (FCEV) that is equipped with a motor as a driving source to drive the vehicle, and a fuel cell and a battery as power sources.

In addition, eco-friendly vehicles may include a hybrid electric vehicle (HEV) that is driven with the combined power of a motor and an engine, and an extended-range electric vehicle (EREV) that uses engine power only for power generation and is driven with motor power alone.

FIG. 1 is a diagram showing an example in which a maximum allowable regenerative braking amount is set in a vehicle in which regenerative braking is performed. Additionally, as shown in FIG. 1, the maximum allowable regenerative braking amount is set in the vehicle in which regenerative braking is performed.

Because the maximum allowable regenerative braking amount is set to a value corresponding to the state of charge (hereinafter referred to as “SoC”) of a battery, the amount of regenerative braking that can be performed varies based on the current battery SoC (%). Additionally, when the battery is in a sufficiently charged state, the regenerative braking function is limited.

In addition, a multiple sets of maximum allowable regenerative braking amount setting data, as shown in FIG. 1, may be provided for use based on battery temperature. Among the multiple sets of maximum allowable regenerative braking amount setting data, the maximum allowable regenerative braking amount setting data corresponding to a current battery temperature may be used.

As shown in FIG. 1, the maximum allowable regenerative braking amount is set to gradually decrease from a certain SoC, and when the battery SoC is 100% (the maximum allowable regenerative braking amount=0), braking force is applied to wheels only by a friction brake device without performing regenerative braking in order to protect the battery.

In the vehicle in which regenerative braking is performed, the total braking force (total braking torque) desired for braking is satisfied by regenerative braking force (regenerative braking torque) by the motor and friction braking force (friction braking torque) by the friction brake device. A hydraulic brake device usually installed in a vehicle is the friction brake device, and generates braking force by friction between a brake pad and a disc.

Because the regenerative braking amount may be limited based on the battery SoC, as shown in FIG. 1, when the battery SoC is sufficient, most of the braking force desired by the vehicle may be generated by the friction brake device.

When a braking load is excessive, the braking force may be significantly reduced as the disc or brake fluid heats up and thus result in a fade or vapor lock phenomenon, thereby leading to a dangerous situation.

In addition, compared to internal combustion engine vehicles, electric vehicles are heavier due to mounting of batteries therein and thus require a large braking force to obtain the same braking deceleration. In particular, when driving downhill in a mountainous area with a fully charged battery, the disc temperature of the friction brake device may rise very high.

FIG. 2 is a diagram comparatively illustrating cases in which a vehicle is driving downhill at a high altitude after a battery is fully charged and when a battery SoC is 80%. Because, after the battery is fully charged, the battery is not rechargeable, regenerative braking is not capable of being performed and only friction braking force may be used when driving downhill. Therefore, a disc temperature may rise.

On the other hand, when the battery SoC is 80%, regenerative braking may be performed at all times when driving downhill until the battery is fully charged, and because braking force distribution between the regenerative braking force and the friction braking force may be performed, the disc temperature may be managed at a lower temperature than when the battery is fully charged.

However, when a motor is capable of generating power but the battery SoC is sufficient and regenerative braking is prohibited, a friction braking load increases. The kinetic energy of the vehicle may be dissipated as heat energy rather than recovered as electrical energy.

The prohibition of regenerative braking due to the battery condition may be affected by factors, such as the battery temperature in addition to the battery SoC. Therefore regenerative braking may be restricted to protect the battery based on the battery temperature.

Accordingly, a technology that, when regenerative braking may be restricted to protect the battery, operates an electrical load using battery power to forcibly consume the battery power so as to enable constant intervention of regenerative braking has been developed.

However, this technology also has technical problems of having to operate the electrical load unnecessarily for the constant intervention of regenerative braking, and having to discard the kinetic energy of the vehicle rather than recover the kinetic energy of the vehicle.

The above information disclosed in this Background section is only to enhance understanding of the background of the disclosure. Therefore, the Background section may contain information that does not form the prior art that is already known in this country to a person of ordinary skill in the art.

### SUMMARY

The present disclosure has been made in an effort to solve the above-described problems associated with prior art. It is an object of the present disclosure to provide an electrical energy management system and method of a vehicle that may enable constant intervention of regenerative braking during braking, enable efficient use of surplus regenerative braking energy that is not capable of charging a battery, and enable the surplus regenerative braking energy to be appropriately used for an air conditioner, in the vehicle in which regenerative braking by a motor is performed.

It is another object of the present disclosure to provide an electrical energy management system and method of a vehicle that may enable surplus regenerative braking energy to be utilized for water electrolysis to reduce driver's anxiety about hydrogen charging in the vehicle that uses hydrogen as a fuel.

In one aspect, the present disclosure provides an electrical energy management system of a vehicle configured to provide regenerative braking. The system includes a motor configured to perform regenerative braking; a battery configured to store regenerative braking energy generated by the motor; and a water storage configured to store water. The system also includes a water electrolyzer configured to receive the water stored in the water storage and the regenerative braking energy generated by the motor as electrical energy, and produce hydrogen using the received water and regenerative braking energy. The system also includes: a hydrogen storage configured to store the hydrogen produced by the water electrolyzer; an air conditioner configured to be operated by selectively receiving electrical energy stored in the battery and the regenerative braking energy generated by the motor; and a controller configured to perform control to selectively supply the regenerative braking energy generated by the motor to the water electrolyzer and the air conditioner.

In another aspect, the present disclosure provides an electrical energy management method of a vehicle configured to provide regenerative braking. The method includes determining, via a controller of the vehicle, total regenerative braking energy based on a driver's brake pedal input value, when the determined total regenerative braking energy exceeds a set maximum allowable regenerative braking amount. The method also includes: determining, via the controller, surplus regenerative braking energy by subtracting the maximum allowable regenerative braking amount from the total regenerative braking energy; and performing, via the controller, control to supply the determined surplus regenerative braking energy as regenerative braking energy used in one or both of a water electrolyzer and an air conditioner. The air conditioner is configured to be operated by selectively receiving electrical energy stored in a battery and regenerative braking energy generated by a motor. The water electrolyzer is configured to: receive water stored in a water storage and the regenerative braking energy generated by the motor as electrical energy; produce hydrogen using the received water and regenerative braking energy; and supply the produced hydrogen to a hydrogen storage.

Other aspects and embodiments of the disclosure are discussed below.

The above and other features of the disclosure are discussed below.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIG. 1 is a diagram showing an example in which the maximum allowable regenerative braking amount is set in a vehicle in which normal regenerative braking is performed;

FIG. 2 is a diagram comparatively illustrating cases in which a vehicle is driving downhill at a high altitude after a battery is fully charged and a battery state of charge (SoC) is 80% in which normal regenerative braking is performed;

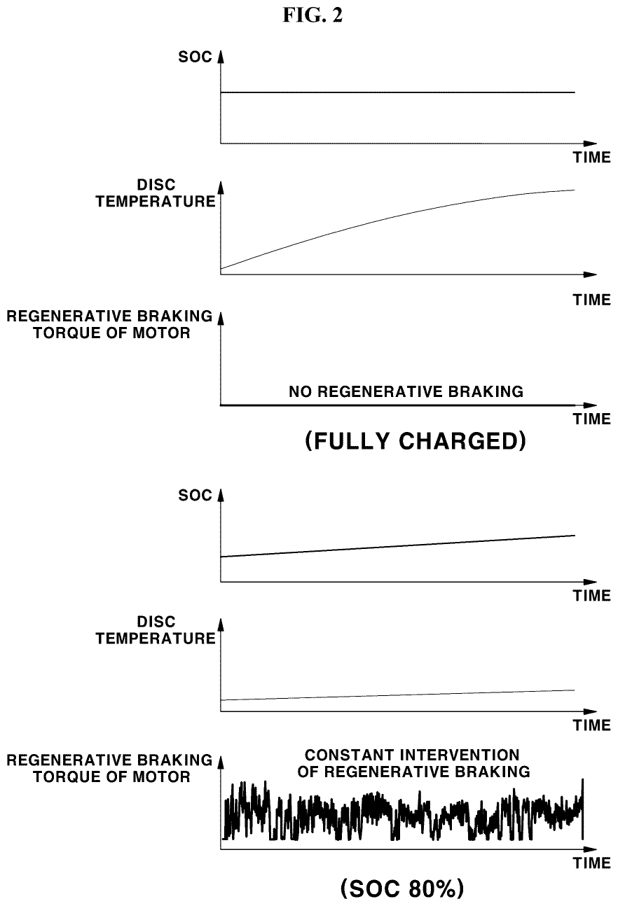

FIG. 3 is a block diagram showing components of an electrical energy management system of a vehicle, according to an embodiment of the present disclosure;

FIG. 4 is a block diagram showing an example configuration of an electrical energy management system, according to an embodiment of the present disclosure;

FIG. 5 is a diagram showing an example of a method of setting a cover percentage, according to an embodiment of the present disclosure;

FIG. 6 is a flowchart showing an electrical energy management method according to an embodiment of the present disclosure; and

FIGS. 7 and 8 are diagrams showing electrical energy flow paths based on operating states, according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes are determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the accompanying drawings. Specific structural or functional descriptions set forth in the embodiments of the present disclosure are merely exemplarily given to describe the embodiments based on the concept of the present disclosure. Additionally, the embodiments based on the concept of the present disclosure may be embodied in different forms. Further, the present disclosure should not be construed as being limited to the embodiments set forth herein, and it should be understood that the present disclosure includes all modifications, equivalents, or substitutes included in the spirit and technical scope of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” and the like.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Wherever possible, the same reference numbers are used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

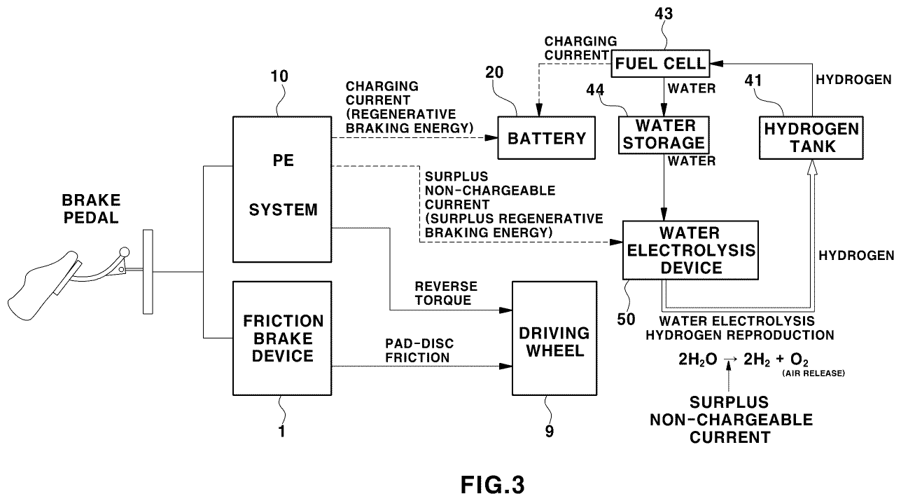

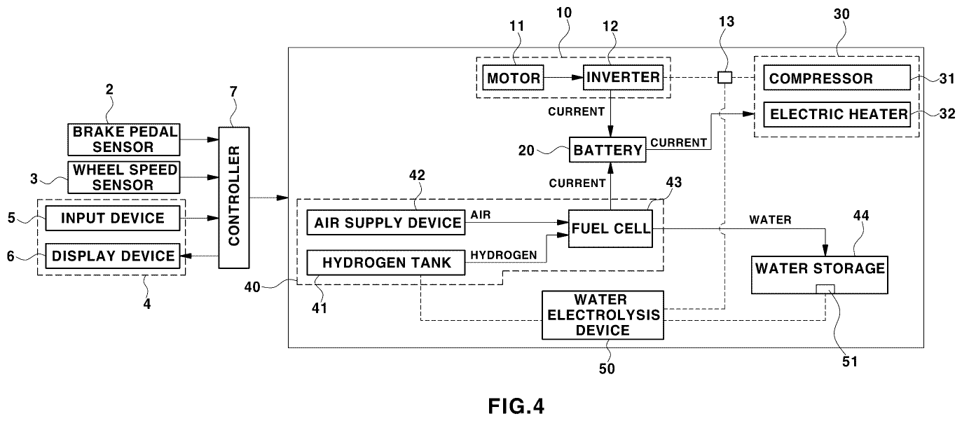

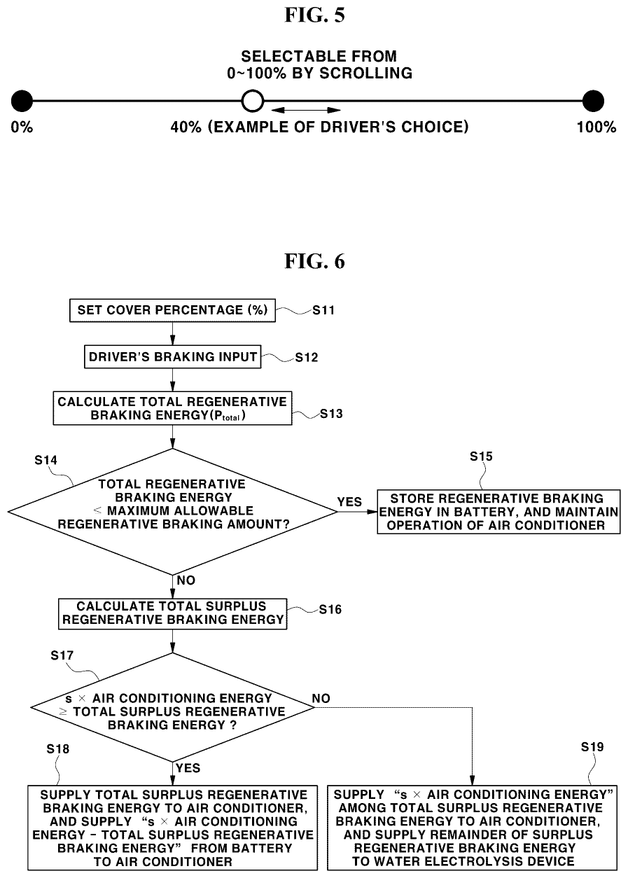

FIG. 3 is a diagram showing components of an electrical energy management system of a vehicle according to an embodiment of the present disclosure. FIG. 4 is a block diagram showing a configuration of an electrical energy management system according to an embodiment of the present disclosure. FIG. 5 is a diagram showing an example of a method of setting a cover percentage, according to an embodiment of the present disclosure.

FIG. 3 illustrates a power electric (PE) system 10, a battery 20, a fuel cell 43, and a water electrolysis device (e.g., water electrolyzer) 50 in a fuel cell electric vehicle (FCEV). The FCEV is equipped with the fuel cell 43 and the water electrolysis device 50, and also illustrates a brake pedal and a friction brake device 1.

The PE system 10 includes, as shown in FIG. 4, a motor 11 that generates driving power for driving the vehicle, and an inverter 12 configured to drive and control the motor 11.

Driving wheels of the vehicle are connected to the motor 11 of the PE system 10 so as to transmit power thereto. In addition, the battery 20 is electrically connected to the motor 11 by the inverter 12 so as to be chargeable and dischargeable.

In the PE system 10, when a driver depresses a brake pedal, the motor 11 is operated as a generator by the rotational force transmitted from the driving wheels 9 to generate electrical energy, and the reverse torque of the motor 11 is applied to the driving wheels 9, thereby allowing the vehicle to decelerate.

In addition, distribution between regenerative braking force and friction braking force is performed to satisfy the total braking force corresponding to a driver's brake pedal input value. The friction brake device 1 generates the friction braking force desired through such braking force distribution, and applies the generated friction braking force to the driving wheels 9.

In the present disclosure, regenerative braking may be performed even under conditions in which a battery state of charge (SoC) is high, and electrical energy generated by the regenerative braking may be used to operate an air conditioner 30 that performs cooling and heating.

In addition, in the present disclosure, regenerative braking may be performed even under conditions in which the battery SoC is high, and the electrical energy generated by the regenerative braking may be used to operate the water electrolysis device 50 that generates hydrogen using water as a fuel.

In order to enable constant intervention of the regenerative braking, surplus regenerative braking energy generated under conditions in which the battery SoC is sufficiently high is used to operate the air conditioner 30, which is an electrical load. The air conditioner 30 that consumes the surplus regenerative braking energy may include at least one, i.e., one or both, of an air conditioner compressor 31 and an electric heater 32 for heating (e.g., a PTC heater).

When only the air conditioner 30 is operated for constant intervention of regenerative braking, as described above, air-conditioning of the vehicle that the driver does not desire may occur, and ultimately, problems, such as mismatch between a target air-conditioning temperature set by a user and an actual interior temperature, and operating noise caused by the compressor 31, may occur.

Therefore, a system and method that enables constant intervention of regenerative braking under vehicle braking conditions considering both vehicle interior air conditioning wanted by the driver and forced consumption of the surplus regenerative braking energy are desired.

For this purpose, the present disclosure allows the water electrolysis device 50 to be operated together with the operation of the air conditioner 30 with the surplus regenerative braking energy. As a result, the configuration allows the driver to select and set a percentage of energy that is covered by the surplus regenerative braking energy among the total energy desired to operate the air conditioner 30, i.e., air conditioning energy.

In the following description, the percentage (%) of energy covered by the surplus regenerative braking energy among the air conditioning energy is defined as a “cover percentage”, and this becomes a weight value to be multiplied by the air conditioning energy to obtain energy to be used for air conditioning among the surplus regenerative braking energy.

In the present disclosure, the surplus regenerative braking energy means regenerative braking energy that is not capable of charging the battery 20 due to the maximum allowable regenerative braking amount among regenerative braking energy generated by regenerative braking.

In addition, the air conditioning energy may be defined as the sum of energy consumption of the compressor 31 (i.e., the output of the compressor 31, W) and the energy consumption of the electric heater 32 (e.g., the PTC heater) of the air conditioner 30.

Accordingly, when the air conditioner 30 is operated to maintain a target air conditioning temperature set by the driver and regenerative braking energy that is not capable of charging the battery 20, i.e., the surplus regenerative braking energy, is generated during braking of the vehicle, the surplus regenerative braking energy to be used to operate the air conditioner 30 among the generated total surplus regenerative braking energy may be determined and distributed based on the cover percentage (%) set by the driver.

In FIG. 4, reference numeral “13” indicates a power distributer controlled by a controller 7, and is configured to distribute the surplus regenerative braking energy to the air conditioner 30 and the water electrolysis device 50 based on the cover percentage (%).

In the present disclosure, the controller 7 performs control of the PE system 10, operation control of the air conditioner 30, battery output control, operation control of a fuel cell system 40, and operation control of the water electrolysis device 50 including a pump 51, in addition to regenerative braking control.

In the present disclosure, when regenerative braking is limited by the maximum allowable regenerative braking amount corresponding to the battery SoC and battery temperature, as described above, and the surplus regenerative braking energy that is not capable of charging the battery 20 is generated, the surplus regenerative braking energy is used to operate the air conditioner 30 and the water electrolysis device 50, thereby enabling constant intervention of regenerative braking during braking of the vehicle.

In the case in which constant intervention of regenerative braking during braking of the vehicle is enabled, only regenerative braking force may be used to brake the vehicle, or braking force distribution between regenerative braking force and friction braking force may be performed and in this case, a friction braking amount may be reduced by a regenerative braking amount used. As a result, because a friction braking load may be reduced, a disc temperature may be maintained at an appropriate temperature without overheating compared to a case in which regenerative braking is not involved.

In addition, when the vehicle to which the present disclosure is applied is a fuel cell electric vehicle (FCEV) equipped with both the fuel cell system 40 and the water electrolysis device 50, it is possible to maximize electrical energy efficiency so that hydrogen is reproduced through regenerative braking of the motor 11.

In addition, in the fuel cell electric vehicle, the driver may set the cover percentage (%) to a lower value or 0% for the purpose of maximizing the electrical energy efficiency rather than air conditioning. When the driver sets the cover percentage (%) to 0% so as to use 100% of the surplus regenerative braking energy for water electrolysis, all the surplus regenerative braking energy may be used to operate the water electrolysis device 50.

Operation of the air conditioner 30 may be stopped, and when the driver wants to prioritize securing hydrogen in the vehicle over interior air conditioning, the driver may set the cover percentage (%) to a small value or 0%. This is an example of a situation in which the air conditioner 30 is turned off and 100% of the surplus regenerative braking energy is used for water electrolysis to maximize electrical energy efficiency.

As is known, in areas where hydrogen charging is insufficient, drivers of fuel cell vehicles may feel anxious because a distance to a hydrogen charging station is far from a current vehicle position, and in this case, they may want to use surplus regenerative braking energy only for water electrolysis and not for air conditioning.

In this case, when the cover percentage is set to a small value or 0%, the surplus regenerative braking energy may be used to operate the water electrolysis device 50 so that hydrogen may be produced in the vehicle, and the produced hydrogen may be used as a fuel for the fuel cell 43 to charge the battery 20.

This may reduce the burden of hydrogen charging even when the driver is not provided with a comfortable interior environment through air conditioning. In areas where hydrogen charging is insufficient, even when inconvenience of the interior environment is tolerated, the hydrogen charging issue may be resolved to some extent.

Of course, even when the cover percentage is set to 0%, operation of the air conditioner 30 may not be completely stopped and the air conditioner 30 may be operated only with the power of the battery 20 based on a driver's choice.

In addition, the driver may adjust the cover percentage (%) so that only a portion of air conditioning energy desired to maintain the target air conditioning temperature set by the driver during driving may be covered by a portion of the surplus regenerative braking energy based on the cover percentage (%), and the remainder of the surplus regenerative braking energy may be used to operate the water electrolysis device 50. In this case, it is possible to maintain the interior temperature at a level close to the target air conditioning temperature.

The air conditioner 30 may be operated based on a driver's setting value so that the vehicle's interior temperature is maintained at the target air conditioning temperature set by the driver. For this purpose, electrical energy corresponding to a deficiency of air conditioning energy may be supplied from the battery 20.

In addition, the driver may set the cover percentage to 100% for the purpose of the comfort of the vehicle's interior so that the entirety of the air conditioning energy is covered by the surplus regenerative braking energy. As a result, the interior temperature may be maintained at the target air conditioning temperature during driving, and when there is any remainder of the surplus regenerative braking energy, it may be used to operate the water electrolysis device 50.

When the driver does not feel anxious about charging hydrogen while driving, there is no need to turn off the air conditioner 30 to make the vehicle's interior temperature too high or low. As a result, the cover percentage (%) may be adjusted so that the surplus regenerative braking energy is appropriately distributed to air conditioning and water electrolysis.

The electrical energy management system according to the present disclosure includes an input device 5 and a display device 6 that allow the driver to perform an operation for the air conditioning-water electrolysis distribution of the surplus regenerative braking energy.

The input device 5 and the display device 6 are electrically connected to the controller 7. When the driver performs the operation for the air conditioning-water electrolysis distribution of the surplus regenerative braking energy, i.e., an operation to select and input the cover percentage (%), the input cover percentage (%) may be stored and set in the controller 7.

The input device 5 and the display device 6 may be an input device 5 and a display device 6 of an audio, video, and navigation (AVN) system. Specifically, the input device 5 and the display device 6 may be a touchscreen 4 of the AVN system that may perform the integrated function of the input device 5 and the display device 6.

FIG. 5 illustrates an example of display information in a smart air conditioning-water electrolysis distribution mode that allows the driver to perform the air conditioning-water electrolysis distribution of the surplus regenerative braking energy by selecting and inputting the cover percentage (%).

In the present disclosure, the operation of the air conditioning-water electrolysis distribution of the surplus regenerative braking energy may be performed by selecting and inputting the cover percentage (%) by the driver, and a scroll method may be used to select and input the cover percentage (%), as shown in FIG. 5.

In other words, when information to select the cover percentage (%) is displayed on the touchscreen 4 of the AVN system in the smart air conditioning-water electrolysis distribution mode under the control of the controller 7, as shown in FIG. 5, the driver may adjust the cover percentage (%) by scrolling a button (shown by a central circle) indicating the cover percentage (%) to the left and right.

The display screen of the smart air conditioning-water electrolysis distribution mode may display a message informing a user that charging of the battery 20 with the regenerative braking energy is limited based on the battery SoC and the battery temperature. The display screen may also guide a user such that the surplus regenerative braking energy that is not capable of charging the battery 20 is capable of being distributed to air conditioning and water electrolysis by setting the cover percentage (%).

On the cover percentage setting screen of the smart air conditioning-water electrolysis distribution mode, the cover percentage may be adjusted to a value between 0% and 100%, and the cover percentage may be decreased to 0% by scrolling the button to the left. In addition, the cover percentage may be increased to 100% by scrolling the button to the right.

Based on the value of the cover percentage (%), which is the percentage of air conditioning energy covered by the surplus regenerative braking energy among the total air conditioning energy, energy distributed for air conditioning and energy distributed for water electrolysis among the total surplus regenerative braking energy may be determined.

As described above, when the cover percentage is set to 0%, there is no surplus regenerative braking energy used for air conditioning (i.e., the air conditioner 30 may be turned off), and all the surplus regenerative braking energy may be used for water electrolysis.

On the other hand, when the cover percentage is set to 100%, the entire air conditioning energy is covered by the surplus regenerative braking energy, and the setting value of the air conditioner 30 may be maintained as the value set by the driver. In other words, the air conditioner 30 may be operated with the target air conditioning temperature set by the driver as a target value (e.g., the interior temperature may be controlled to the target air conditioning temperature).

When all or a portion of the air conditioning energy may be covered by the surplus regenerative braking energy based on the cover percentage (%), but the entire surplus regenerative braking energy is less than the energy obtained by reflecting the cover percentage (%) in the air conditioning energy, the electrical energy of the battery 20 may be supplied to the air conditioner 30 to operate the air conditioner 30.

In addition, when supplying surplus regenerative braking energy corresponding to the cover percentage (%) to the air conditioner 30, and the total air conditioning energy desired for air conditioning is greater than the surplus regenerative braking energy corresponding to the cover percentage (%), insufficient energy may be supplied from the battery 20. Alternatively, when the total air conditioning energy desired for air conditioning is less than the surplus regenerative braking energy, the remainder of the surplus regenerative braking energy may be supplied to the water electrolysis device 50 to be used for water electrolysis.

For example, when the driver sets the cover percentage to 40%, an amount of energy corresponding to 40% of the air conditioning energy is covered by the surplus regenerative braking energy, and it may be difficult to operate the air conditioner 30 to maintain the target air conditioning temperature set by the driver. In other words, it may be impossible to control the interior temperature to the target temperature.

However, in order to secure as much as hydrogen as possible through the water electrolysis device 50 while reducing use of the power of the battery 20 and operation of the fuel cell 43, the battery power may not be supplied to the air conditioner 30.

Alternatively, when the total surplus regenerative braking energy is less than the energy corresponding to 40% of the air conditioning energy, insufficient energy may be supplied from the battery 20. On the other hand, when the total surplus regenerative braking energy is greater than the energy corresponding to 40% of the air conditioning energy, the remainder of the surplus regenerative braking energy may be supplied to the water electrolysis device 50 to be used for water electrolysis.

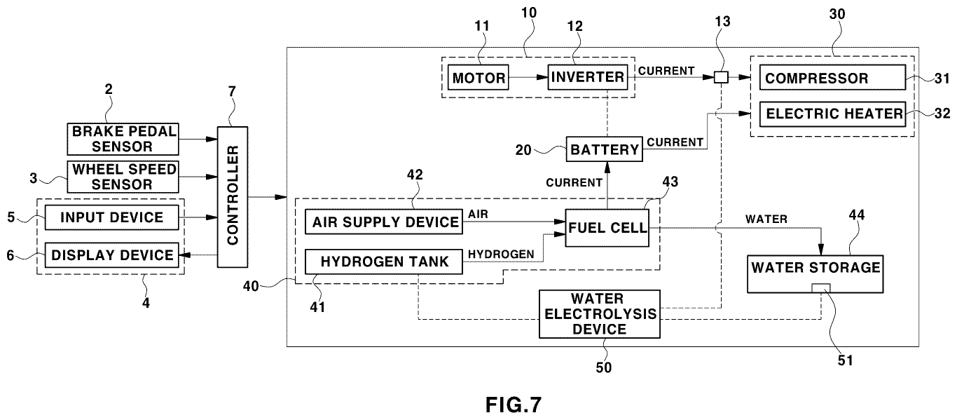

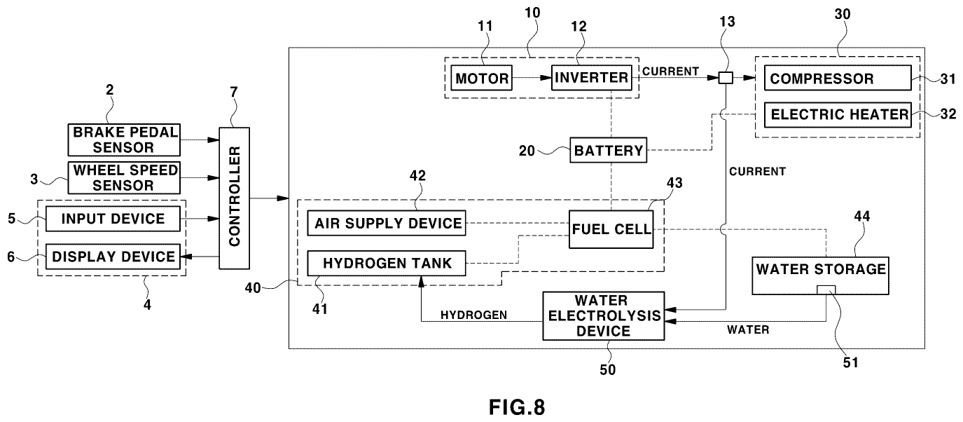

FIG. 6 is a flowchart showing an electrical energy management method according to an embodiment of the present disclosure. FIGS. 7 and 8 are diagrams showing electrical energy flow paths based on operating states, according to embodiments of the present disclosure.

Hereinafter, the operating states of the present disclosure are described with reference to FIGS. 4 and 6-8.

FIG. 4 shows an operating state in which regenerative braking energy and energy generated by the fuel cell 43 are supplied to the battery 20 to charge the battery 20, and the air conditioner 30 is operated with the battery charging energy.

FIG. 7 shows an operating state in which the air conditioner 30 is operated with surplus regenerative braking energy, and insufficient energy during operation of the air conditioner 30 is supplied from the battery 20. FIG. 8 shows an example in which the water electrolysis device 50 is operated with the remainder of the surplus regenerative braking energy after operating the air conditioner 30.

In the examples of FIGS. 7 and 8, the regenerative braking energy generated by the motor 11 is not supplied to the battery 20, and this state may be a state in which the maximum allowable regenerative braking amount corresponding to the current battery SoC and battery temperature is 0%.

In the present disclosure, when a control subject in charge of electrical energy management control is the controller 7, the controller 7 controls supply and cut-off of electrical energy to the air conditioner 30 and the water electrolysis device 50, and specifically, supply of regenerative braking energy, supply of air conditioning energy, the supply of fuel cell power generation energy, and supply of surplus regenerative braking energy.

In addition, the controller 7 performs braking control based on a brake pedal input value detected by a brake pedal sensor (BPS) 2, and controls operation of the motor 11 and the inverter 12 of the PE system 10 during a regenerative braking control process during the braking control.

In more detail, when the driver sets the cover percentage (%) (S11) and depresses the brake pedal while driving (S12), the controller 7 determines a total braking torque desired based on the brake pedal input value detected by the brake pedal sensor 2, and determines a regenerative braking torque that satisfies the total braking torque. Subsequently, total regenerative braking energy Pₜₒₜₐₗ is determined from the regenerative braking torque.

The total regenerative braking energy Pₜₒₜₐₗ may be determined from a regenerative braking torque of each wheel and a wheel speed detected by each wheel speed sensor 3, as shown in Mathematical expression 1 below.

$${P}_{total} = {T}_{regen \_ fl} \times {ω}_{fl} + {T}_{regen \_ fr} \times {ω}_{fr} + {T}_{regen \_ rl} \times {ω}_{rl} + {T}_{regen \_ rr} \times {ω}_{rr} \qquad [ Mathematical expression 1 ]$$

T_{regen_fl} indicates the regenerative braking torque of a front left wheel, T_{regen_fr} indicates the regenerative braking torque of a front right wheel, T_{regen_rl} indicates the regenerative braking torque of a rear left wheel, and T_{regen_rr} indicates the regenerative braking torque of a rear right wheel.

In addition, ω_{fl} indicates a wheel speed of the front left wheel, ω_{fr} indicates a wheel speed of the front right wheel, ωᵣₗ indicates a wheel speed of the rear left wheel, and ωᵣᵣ indicates a wheel speed of the rear right wheel.

In order to generate the surplus regenerative braking energy in Mathematical expression 1, the condition of Mathematical expression 2 below may be satisfied.

$${P}_{total} > {P}_{max \_ recovering \_ power} \qquad [ Mathematical expression 2 ]$$

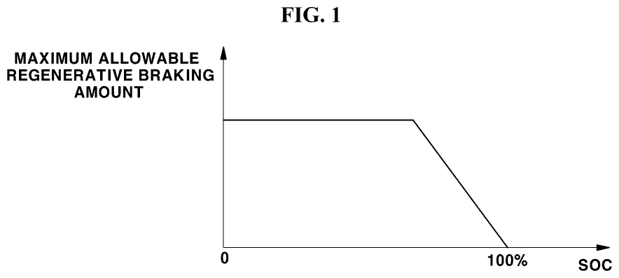

P_{max_recovering_power} is the maximum allowable regenerative braking amount value corresponding to the current battery SoC and battery temperature, and may be obtained from the setting data, as shown in FIG. 1.

In this way, when the current total regenerative braking energy is greater than the maximum allowable regenerative braking amount corresponding to the current battery SoC and battery temperature, surplus regenerative braking energy may be generated.

The controller 7 determines whether the condition of Mathematical expression 2 is satisfied (S14), and upon determining that the condition of Mathematical expression 2 is not satisfied, the total regenerative braking energy Pₜₒₜₐₗ is stored in the battery 20, and the air conditioner 30 maintains the current state (S15). The air conditioner 30 including the compressor 31 and the electric heater 32 may be operated with the power of the battery 20, as shown in FIG. 4.

In addition, the total regenerative braking energy generated by the motor 11 may be stored in the battery 20, and at the same time, when the fuel cell system 40 is driven, electrical energy generated by the fuel cell 43 may be stored in the battery 20.

In FIG. 4, reference numeral “40” indicates the fuel cell system, and FIG. 4 illustrates main components of the fuel cell system 40. The fuel cell system 40 includes: a hydrogen tank 41 that stores hydrogen, which is a fuel among reaction gases; an air supply device 42 that supplies air, which is an oxidizer among the reaction gases; and the fuel cell (stack) 43 that produces electrical energy and water based on the electrochemical reaction (fuel cell reaction) of the reaction gases.

The water produced by the electrochemical reaction in the fuel cell 43 is discharged to the outside and stored in a water storage 44, and the water stored in the water storage 44 may be used as a fuel in the water electrolysis device 50. The state of FIG. 4 is a state in which the water electrolysis device 50 is not operated.

The water electrolysis device 50 includes a water electrolysis stack (not shown) that produces hydrogen and oxygen by the water electrolysis reaction of water and electrical energy. While operating the water electrolysis device 50, when the water stored in the water storage 44 is supplied to the water electrolysis stack by the pump 51, hydrogen and oxygen are produced by the water electrolysis reaction of water and electrical energy in the water electrolysis stack. The produced hydrogen is stored in the hydrogen tank 41, which is a hydrogen storage of the vehicle, and the oxygen is released to the outside (e.g., exterior).

The configuration of the fuel cell system 40 and the water electrolysis device 50 is well known to those having ordinary skill in the art, and a detailed description thereof has been omitted.

When the condition of Mathematical expression 2 is satisfied in Operation S14, surplus regenerative braking energy Pₛᵤᵣₚₗᵤₛ is generated, and the controller 7 may calculate the surplus regenerative braking energy Pₛᵤᵣₚₗᵤₛ using Mathematical expression 3 below (S16).

$${P}_{surplus} = {P}_{total} - {P}_{max \_ recovering \_ power} \qquad [ Mathematical expression 3 ]$$

In addition, assuming that the operating output of the air conditioner 30, i.e., compressor energy consumption, which is the output of the compressor 31, to maintain the interior temperature at the target air conditioning temperature set by the driver for interior air conditioning is P_{AC_Comp}, electric heater energy consumption, which is the output of the electric heater 32, is P_{PTC_Heater}, and the cover percentage (%) set by the driver is s (0-100%), the controller 7 determines whether the current state satisfies “s×(P_{AC_Comp}+P_{PTC_Heater})≥Pₛᵤᵣₚₗᵤₛ” (S17). “P_{AC_Comp}+P_{PTC_Heater}” indicates the air conditioning energy, and Pₛᵤᵣₚₗᵤₛ indicates the surplus regenerative braking energy.

Upon determining that the current state satisfies “s×(P_{AC_Comp}+P_{PTC_Heater})≥Pₛᵤᵣₚₗᵤₛ”, the controller 7 causes all the surplus regenerative braking energy to be supplied to the air conditioner 30 to be used to operate the air conditioner 30, and controls the battery 20 to supply energy corresponding to “s×(P_{AC_Comp}+P_{PTC_Heater})−Pₛᵤᵣₚₗᵤₛ” to the air conditioner 30 (S18).

On the other hand, upon determining that the current state satisfies “s×(P_{AC_Comp}+P_{PTC_Heater})<Pₛᵤᵣₚₗᵤₛ”, among all the surplus regenerative braking energy, surplus regenerative braking energy “s×(P_{AC_Comp}+P_{PTC_Heater})” corresponding to the cover percentage s (%) for the air conditioning energy “P_{AC_Comp}+P_{PTC_Heater}” is supplied to the air conditioner 30 to be used to operate the air conditioner 30. The remainder of the surplus regenerative braking energy “Pₛᵤᵣₚₗᵤₛ−s×(P_{AC_Comp}+P_{PTC_Heater})” is supplied to the water electrolysis device 50 to be used to operate the water electrolysis device 50 (S19).

When the water electrolysis deice 50 is operated, the water electrolysis stack is supplied with water stored in the water storage 44 as a fuel, and hydrogen produced by the water electrolysis reaction of water and electrical energy equivalent to the remainder of the surplus regenerative braking energy supplied to the water electrolysis device 50 is stored in the hydrogen tank 41, and oxygen produced by the water electrolysis reaction is released to the outside.

In this way, the electrical energy management system and method of the vehicle according to the present disclosure have been described in detail. As the vehicle to which the present disclosure is applied, any vehicle that is capable of performing regenerative braking by a motor and uses hydrogen as a fuel may be employed.

For example, in addition to the above-described fuel cell vehicle equipped with the fuel cell system and the electrolysis device, the present disclosure is applicable to an extended range electric vehicle (EREV) equipped with a hydrogen internal combustion engine that uses hydrogen as a fuel, a generator, and an electrolysis device.

The power of the hydrogen internal combustion engine is used only to operate the generator, and the vehicle is driven only with the power of a motor operated with battery power. In addition, hydrogen produced by the water electrolysis device is used as a fuel for the hydrogen internal combustion engine.

It should be apparent from the above description, an electrical energy management system and method according to the present disclosure may enable constant intervention of regenerative braking during braking in a vehicle in which regenerative braking is performed by a motor.

In addition, according to the present disclosure, surplus regenerative braking energy that is not capable of charging a battery may be efficiently utilized, thereby being appropriately used in an air conditioner.

In addition, according to the present disclosure, the surplus regenerative braking energy may be used for water electrolysis, thereby being capable of reducing driver's anxiety about charging hydrogen in a vehicle that uses hydrogen as a fuel.

Although the present disclosure has been described in detail with reference to embodiments thereof, the scope of the present disclosure is not limited to the above-described embodiments. Furthermore, it should be understood that various modifications and improvements made by those having ordinary skill in the art using the basic concept of the present disclosure defined in the following claims are also included in the scope of the present disclosure.

What is claimed is:

1. An electrical energy management system of a vehicle configured to perform regenerative braking, the system comprising:
a motor configured to perform the regenerative braking;
a battery configured to store regenerative braking energy generated by the motor;
a water storage configured to store water;
a water electrolyzer configured to receive the water stored in the water storage and the regenerative braking energy generated by the motor as electrical energy, and produce hydrogen using the received water and regenerative braking energy;
a hydrogen storage configured to store the hydrogen produced by the water electrolyzer;
an air conditioner configured to receive electrical energy stored in the battery and the regenerative braking energy generated by the motor; and
a controller configured to supply the regenerative braking energy generated by the motor to the water electrolyzer and the air conditioner.

2. The system of claim 1, further comprising a fuel cell system configured to generate electrical energy using the hydrogen stored in the hydrogen storage as a fuel.

3. The system of claim 1, further comprising:
a hydrogen internal combustion engine configured to use the hydrogen stored in the hydrogen storage as a fuel; and
a generator configured to generate electrical energy with power of the hydrogen internal combustion engine to charge the battery.

4. The system of claim 1, wherein the controller is configured to determine total regenerative braking energy based on a driver's brake pedal input value, and
wherein when the determined total regenerative braking energy exceeds a set maximum allowable regenerative braking amount, the controller is further configured to:
determine surplus regenerative braking energy by subtracting the maximum allowable regenerative braking amount from the total regenerative braking energy; and
supply the determined surplus regenerative braking energy as the regenerative braking energy used in one or both of the water electrolyzer and the air conditioner.

5. The system of claim 4, further comprising a power distributer configured to be controlled by the controller and selectively distribute the surplus regenerative braking energy to the water electrolyzer and the air conditioner.

6. The system of claim 4, further comprising an input device configured to set a cover percentage, wherein the cover percentage is a percentage (%) of energy to be covered by the surplus regenerative braking energy among air conditioning energy to operate the air conditioner.

7. The system of claim 6, further comprising a display configured to display information for selecting and inputting the cover percentage.

8. The system of claim 6, wherein the controller is further configured to supply the surplus regenerative braking energy to the air conditioner when a value obtained by multiplying the air conditioning energy by the cover percentage is greater than or equal to the surplus regenerative braking energy.

9. The system of claim 8, wherein the controller is further configured to supply energy, obtained by subtracting the surplus regenerative braking energy from the value obtained by multiplying the air conditioning energy by the cover percentage, from the battery to the air conditioner, when the value obtained by multiplying the air conditioning energy by the cover percentage is greater than or equal to the surplus regenerative braking energy.

10. The system of claim 6, wherein, when the surplus regenerative braking energy is greater than a value obtained by multiplying the air conditioning energy by the cover percentage, the controller is further configured to:
supply a portion of the surplus regenerative braking energy corresponding to the value obtained by multiplying the air conditioning energy by the cover percentage, among the surplus regenerative braking energy to the air conditioner; and
simultaneously supply a remainder of the surplus regenerative braking energy, obtained by subtracting the portion of the surplus regenerative braking energy supplied to the air conditioner from the surplus regenerative braking energy, to the water electrolyzer.

11. The system of claim 6, wherein the cover percentage is set to a value within a range of 0 to 100%.

12. The system of claim 1, wherein the controller is further configured to determine total regenerative braking energy based on a driver's brake pedal input value, and
wherein when the determined total regenerative braking energy is less than or equal to a set maximum allowable regenerative braking mount, the controller is further configured to:
store the total regenerative braking energy in the battery; and
maintain a current operating state of the air conditioner.

13. An electrical energy management method of a vehicle configured to perform regenerative braking, the method comprising:
determining, via a controller of the vehicle, total regenerative braking energy based on a driver's brake pedal input value;
determining, via the controller, surplus regenerative braking energy by subtracting a maximum allowable regenerative braking amount from the total regenerative braking energy when the determined total regenerative braking energy exceeds the maximum allowable regenerative braking amount; and
supplying, via the controller, the determined surplus regenerative braking energy as regenerative braking energy used in one or both of a water electrolyzer and an air conditioner,
wherein the air conditioner is configured to receive electrical energy stored in a battery and regenerative braking energy generated by a motor, and
wherein the water electrolyzer is configured to receive water stored in a water storage and the regenerative braking energy generated by the motor as electrical energy, produce hydrogen using the received water and regenerative braking energy, and supply the produced hydrogen to a hydrogen storage.

14. The method of claim 13, wherein the vehicle comprises a fuel cell system configured to generate electrical energy using the hydrogen stored in the hydrogen storage as a fuel.

15. The method of claim 13, wherein the vehicle comprises:
a hydrogen internal combustion engine configured to use the hydrogen stored in the hydrogen storage as a fuel; and
a generator configured to generate electrical energy with power of the hydrogen internal combustion engine to charge the battery.

16. The method of claim 13, further comprising inputting a cover percentage set via an input device to the controller,
wherein the cover percentage is a percentage (%) of energy to be covered by the surplus regenerative braking energy among air conditioning energy to operate the air conditioner.

17. The method of claim 16, further comprising supplying, via the controller, the surplus regenerative braking energy to the air conditioner when a value obtained by multiplying the air conditioning energy by the cover percentage is greater than or equal to the surplus regenerative braking energy,.

18. The method of claim 17, further comprising supplying, via the controller, energy obtained by subtracting the surplus regenerative braking energy from the value obtained by multiplying the air conditioning energy by the cover percentage, from the battery to the air conditioner when the value obtained by multiplying the air conditioning energy by the cover percentage is greater than or equal to the surplus regenerative braking energy.

19. The method of claim 17, wherein, when the surplus regenerative braking energy is greater than the value obtained by multiplying the air conditioning energy by the cover percentage, the method further comprises:
supplying, via the controller, a portion of the surplus regenerative braking energy corresponding to the value obtained by multiplying the air conditioning energy by the cover percentage, among the surplus regenerative braking energy to the air conditioner; and
simultaneously supplying, via the controller, a remainder of the surplus regenerative braking energy, obtained by subtracting the portion of the surplus regenerative braking energy supplied to the air conditioner from the surplus regenerative braking energy, to the water electrolyzer.

20. The method of claim 13, wherein, when the determined total regenerative braking energy is less than or equal to a set maximum allowable regenerative braking mount, the method further comprises:
storing, via the controller, the total regenerative braking energy in the battery; and
maintaining, via the controller, a current operating state of the air conditioner.
